(19) United States
(12) Patent Application Publication
(10) Pub. No.: US 2012/0206002 A1
(43) Pub. Date: Aug. 16, 2012

(54) HIGH EFFICIENCY ELECTRIC MOTOR AND POWER COGENERATION UNIT

(76) Inventor: Robert Ray Holcomb, Nokomis, FL (US)

(21) Appl. No.: 13/503,569

(22) PCT Filed: Oct. 19, 2010
(86) PCT No.: PCT/IB2010/002659

§ 371 Date: Apr. 23, 2012

Related U.S. Application Data
(60) Provisional application No. 61/279,536, filed on Oct. 22, 2009.

(51) Int. Cl. H02K 47/00; H02K 53/00

(52) U.S. Cl. 310/113; 74/DIG. 9

(57) ABSTRACT

A method and apparatus for reducing drag in an electric motor-power cogenerator is provided. Wound pole irons are formed around a stator having slots containing induction windings. Ends of the pole irons extend into or near the slots and are supported by a support structure that forms an opening. Other ends extend towards the opening. Stator inserts containing free-wheeling permanent magnet inserts are distributed around a rotor inserted into the support structure opening. The permanent magnet inserts are inserted into cavities along the periphery of the rotor and include a pair of pole sections with a first magnetic polarity and a second magnetic polarity. The windings of the pole irons are sequentially energized to provide a moving field and a torque to rotate the rotor. The permanent magnet inserts freely rotate into alignment with ends of the pole irons to increase a flux density and reduce drag.

### FIELD

The present invention relates generally to a decreased drag electric motor and power generating machine, and more particularly to reducing drag through the use of sequentially activated wound poles that interact with free-wheeling permanent magnet inserts to reduce magnetic drag.

### BACKGROUND

Rapid consumption of exhaustible energy from the earth, largely in the form of fossil fuels and rapid depletion of associated energy resources and accompanying environmental pollution and climate change drives the clear need for alternative energy supplies. Existing energy supplies must be used more efficiently.

In view of these and other issues, the need for sustainable power generation units is obvious. Renewable energy sources such as solar, wind, hydroelectric, electrostatic, temperature differential and geothermal energy have significant problems of availability, reliability and expense. Even gravity, if it could be efficiently harnessed, could provide a most attractive alternative.

One contribution to increasing consumption efficiency and sustainability is to increase the efficiency of electrical power generation. Increasing the conversion efficiency associated with converting mechanical energy to electrical power can provide potentially large gains. An ordinary electric generator typically converts close to 99% of supplied mechanical power into electric power based on a conventional 100% conversion efficiency comparison factor of one horsepower per 746 watts generated, however such a factor is somewhat misleading as true efficiency that takes into account friction losses and the like, may be significantly less. Still further gains can be achieved using superconducting technology. For example, a superconducting generator can be around 10-times smaller than a conventional generator for the same output.

While such gains are attractive, the expenses and challenges of implementing superconducting solutions are well known. It is therefore also desirable to achieve efficiency gains that are centered around more conventional structures. For example, if the reaction force or magnetic drag can be reduced or eliminated from the armature of an alternating current (AC) or direct current (DC) generator, the efficiency could be theoretically increased by 400-500%. Under such an increase in efficiency, one horsepower could generate up to 3,730 watts. Still further, by combining superconductivity with reduced magnetic drag, a greater than 10-fold increase in efficiency may be possible.

To better understand the rudiments of power generation, it is commonly known that every atom has a nucleus composed of positively charged protons and uncharged neutrons. Negatively charged electrons orbit the nucleus. In most atoms, the number of electrons is equal to the number of protons in the nucleus, so that there is no net charge. If the number of electrons is less than the number of protons, then the atom has a net positive charge. If the number of electrons is greater than the number of protons, then the atom has a net negative charge.

While on an aggregate scale, the universe is electrically neutral, local concentrations of charge throughout biological and physical systems are responsible for all electrical activity. Further, not all electrons are involved in the structure of material. Vast numbers of electrons which are loosely bound “electrons at large” are in equilibrium with outer shell electrons of atoms in the environment. It is from this pool of electrons in the atmosphere and in the ground, when set into combined motion along a path, that an electric current is generated. Thus, if electrical pressure from a generator is applied to an electrical conductor, such as copper wire, and the circuit closed, electrons will flow along the wire from negative to positive, from atom to atom forming an electric current.

The movement of energy associated with electrical current flow occurs at the speed of light, or approximately 186,000 miles per second.

For conceptual purposes, a wire connected to a DC power source will cause electrons to flow through the wire in a manner approximating water flowing through a pipe. The path of any one electron can be anywhere within the volume of the wire or even at the surface. When an AC voltage is applied across a wire it will cause electrons to vibrate back and forth in such a manner as to generate magnetic fields that push electrons toward the surface of the wire. As the frequency of the applied AC signal increases, the electrons are pushed farther away from the center and toward the surface.

A conventional electric power generator contains two main parts: a stator and a rotor. The stator is generally made of iron or other ferro-magnetic material and contains longitudinal slots having a certain depth and width and in which wire coils are wound in such a fashion to allow electric power to be generated when magnetic fields emanating from the rotor move past the coils. The rotor contains a specific arrangement of magnets, which are generally wound armature electro-magnets whose strength is governed by the amount of current flowing in the armature windings. It should be noted that, while permanent magnets have attractive properties, the use of permanent magnets, particularly in large scale applications, have traditionally been avoided due to the relatively high cost of magnetic material. When the rotor spins inside the stator, the magnetic fields from the rotor induce a current in the stator windings thus generating what is referred to as electrical power.

The energy required to spin the rotor is typically supplied by a drive unit of some kind, such as an electrical drive motor, diesel or other fossil fuel motor, steam turbine or the like. At typical efficiencies, only 20% of the energy input by the driver motor is devoted to creating electric power. The remaining 80% is dissipated by magnetic drag, or braking forces, that develop between the rotor and the stator.

When current is supplied to a load from a conventional generator, a magnetic force or reaction force is created by the flow of the load current in the generator conductors that opposes the rotation of the generator armature. If the load current in the generator conductors increases, the drag associated with the reaction force increases. More force must be applied to the armature as the toad increases to keep the armature from slowing. Increasing drag and increasing load current leads to decreasing conversion efficiency and can eventually lead to destructive consequences for generator equipment.

It would be desirable for a way of increasing generator efficiency by reducing the motor reaction effect and the corresponding negative consequences.

### SUMMARY

Various exemplary embodiments are discussed and described herein involving aspects of an electric machine, such as an electric motor and power cogeneration unit that produces power with high efficiency and low drag. Accordingly, an exemplary method for reducing drag in an electric motor-power co-generator can include forming a series of wound lateral pole irons around the inner periphery of a stator. The stator is further provided with slots around the inner periphery that contain induction windings. First ends of the lateral pole irons extend into the slots and are supported by a lateral pole iron support structure forming a circular opening that is concentric with the inner periphery of the stator. Second ends of the lateral pole irons extend towards the circular opening. Stator inserts containing free-wheeling permanent magnet inserts can be distributed along an outer periphery of a rotor inserted into the circular opening of the lateral pole iron support structure. The free-wheeling permanent magnet inserts can be inserted into cavities along the outer periphery of the rotor and can each include a pair of pole sections with a first magnetic polarity and a second magnetic polarity. The pole sections can be made for example, from neodymium, samarium-cobalt or the like. The windings of the lateral pole irons can be sequentially energized so as to provide a moving field such that a torque is applied to rotate the rotor, and pole sections of the free-wheeling permanent magnet inserts are free to rotate into alignment with ones of the second ends of the lateral pole irons to increase a flux density in the lateral pole irons, the first ends of the lateral pole irons inducing a current flow into the induction windings.

The stator, the support structure, and the rotor can be divided into N equally spaced sectors, which can be twelve in embodiments described herein, by radii emanating from a common center point on a common central longitudinal axis. The free-wheeling permanent magnet inserts can be inserted into positions along the outer periphery of the rotor. Based on the distribution of the sectors and the like, N/2 groups of two of the N equally spaced sectors can be established. First ones of the lateral pole iron windings in first ones of the sectors in the N/2 groups can be wound such that the first lateral pole irons have a first magnetic polarity. Second ones of the lateral pole iron windings in second ones of the sectors in the N/2 groups can be wound such that the second lateral pole irons have a second magnetic polarity. It will be appreciated that the slots, the lateral pole irons and the free-wheeling permanent magnet inserts are axially aligned along a respective lengthwise axes thereof such that a lengthwise axis of the free-wheeling permanent magnet inserts is in normal alignment with a depthwise axis of the slots and lateral pole irons. The free-wheeling permanent magnet inserts magnetically shielding within the rotor such that flux generated thereby is directed into the second ends of the lateral pole irons so as to minimize flux leakage and magnetic drag and to increase flux coupling thereinto. The free-wheeling permanent magnet inserts can further be inserted into respective openings provided in the rotor that are arranged in lengthwise alignment with the slots and the lateral pole irons. The openings correspond to a longitudinal opening of the slots and provide magnetic communication with the corresponding second ends of the lateral pole irons that are disposed, for example, within or near the slots.

The sequential energizing of the windings of the lateral pole irons includes bringing first ones of the free-wheeling permanent magnet inserts into alignment, such as through the self initiated free-wheeling action thereof, with first ones of the second ends of the lateral pole irons such that as the torque is provided to rotate the rotor, the first ones of the free-wheeling permanent magnet inserts maintain the alignment, for example, during at least a portion of the rotation, with the first ones of the second ends of the lateral pole irons. As the rotor rotates past the second ends of the lateral pole irons and the alignment is maintained, a maximum flux density associated with the moving field is also maintained so as to induce a maximum current flow in the induction windings and reduce a magnetic drag associated with the rotation.

In accordance with embodiments, an electromagnetic assembly for an electric motor and power co-generation can be provided and includes, for example, a stator having a plurality of slots arranged on a stator periphery of an inner stator opening thereof. A plurality of lateral pole irons can be coupled to the stator such that first ends of each of the plurality of lateral pole irons are coupled to respective ones of the plurality of slots. The slots and the lateral pole irons can be aligned along a lengthwise and depthwise axis. The plurality of lateral pole irons can be supported by a support structure that is positioned within the inner stator opening on a common central axis. The support structure has a support structure opening in the center thereof. The stator and the support structure can have a substantially circular shape and can therefore be arranged in a concentric fashion. The lateral pole irons have windings and second ends directed toward the support structure opening. A rotor can be positioned within the support structure opening and can have a plurality of cavities on a rotor outer periphery. The rotor can be coupled to a central shaft and can have a plurality of free-wheeling permanent magnet inserts inserted into the cavities. Each of the cavities has an opening capable of being positioned adjacent to the second ends of the lateral pole irons. Each of the plurality of free-wheeling permanent magnet inserts can have a pair of magnetic pole sections having a first magnetic polarity and a second magnetic polarity. The pole sections can be made from neodymium, samarium-cobalt or the like depending on the application. Each of the free-wheeling permanent magnet inserts are capable of rotating about a longitudinal axis. In some embodiments, the pole sections can be electromagnets such as wound armature electromagnets.

Windings of the plurality of lateral pole irons are sequentially energized to create a moving field and to apply a torque on the rotor causing a rotation of the shaft. The free-wheeling permanent magnet inserts can rotate into alignment with the second ends of energized ones of the lateral pole irons and can free-wheel in order to maintain alignment as the rotor and the field rotates so as to provide maximum flux density in the lateral pole iron and the induction windings in a corresponding one of the plurality of slots to induce a current flow therein. The stator, the support structure and the rotor can be divided into N equally spaced sectors by radii emanating from a common center point on a common central longitudinal axis. An activation circuit coupled to the windings of the lateral pole irons can apply three phases of alternating current power to sequentially energize ones of the windings of the lateral pole irons. The activation circuit can include a rectifier circuit for applying rectified versions of three phases of alternating current power to sequentially energize ones of the windings of the lateral pole irons. Each of the plurality of the lateral pole irons can be disposed respectively above each of the plurality of the slots such that the induction coil windings disposed in the plurality of slots are exposed to a concentrated amount of magnetic flux generated when the windings of the lateral pole irons are energized and a magnetic circuit is completed by the free-wheeling permanent magnet inserts. The plurality of free-wheeling permanent magnet inserts are further capable of rotating in synchronized relation with the magnetic field such that when the windings of the lateral pole irons are sequentially energized, the free-wheeling permanent magnet inserts are rotated into alignment with the second ends of the lateral pole irons so as to provide maximum flux density in the induction windings to induce a current flow therein and to reduced magnetic drag on the rotor.

In an embodiment, each of the plurality of free-wheeling permanent magnet inserts is contained within a containment sleeve that shields the rotor from magnetic fields produced by each of the free-wheeling permanent magnet inserts. The containment sleeve is made from alternating layers of mu metal and austenitic steel. The containment sleeve can have one or more bearings to support rotation of the containment sleeve and the contained free-wheeling permanent magnet insert member.

Therefore, it is an object to present a method and apparatus for reducing the electromagnetic drag in an electric motor to thereby improve efficiency and simultaneously cogenerate electric power which is available for any appropriate use.

It is an additional object to present a method and apparatus by which electro-magnetic poles of the invention are constructed and activated in the proper sequence by a three-phase power feed such that the electromagnetic drag is minimized.

It is a further object to present exemplary freewheeling armature magnetic poles to reduce drag by freely moving into and maintaining an aligned position with electromagnetic poles of a rotor to reduce drag and increase flux intensity.

It is an additional object to present exemplary induction coils activated by wound lateral pole iron and to thereby generate power as the motor/generator produces mechanical energy on an exemplary motor shaft.

It is a further object to sequence the application of three-phase power both in an alternating current (AC) and a direct current (DC) embodiment.

### BRIEF DESCRIPTION OF THE DRAWINGS

In order that embodiments may be fully and more clearly understood by way of non-limitative examples, the following description is taken in conjunction with the accompanying drawings in which like reference, numerals designate similar or corresponding elements, regions and portions, and in which:

FIG. 1A is a diagram illustrating a lateral view of an exemplary rotor containment unit and end bells in accordance with one or more embodiments;

FIG. 1B is a diagram illustrating a lateral view of an exemplary stator and leads in accordance with one or more embodiments;

FIG. 2 is a diagram illustrating a cross sectional end view of an exemplary stator and stator insert portion including a rotor and exemplary free-wheeling permanent magnet inserts and lateral pole irons in accordance with one or more embodiments;

FIG. 3A is a diagram further illustrating a cross sectional end view of an exemplary stator having induction windings and stator insert portion including a rotor and exemplary free-wheeling permanent magnet inserts and wound lateral pole irons in accordance with one or more embodiments;

FIG. 3B is a diagram further illustrating details of a partial cross sectional end view of an exemplary stator showing relative numbering used in a description of one or more embodiments;

FIG. 4 is a diagram illustrating a lateral oblique view of an exemplary containment sleeve inserted into a cylinder insert cavity of an exemplary rotor in accordance with one or more embodiments;

FIG. 5 is a diagram illustrating an lateral oblique view of an exemplary containment sleeve for an free-wheeling permanent magnet insert including bearings in accordance with one or more embodiments;

FIG. 6 is a diagram illustrating an end view of an exemplary containment sleeve, free-wheeling permanent magnet insert, and shielded cylinder insert cavity in accordance with one or more embodiments;

FIG. 7A is graph illustrating a pattern of separate phases of three-phase power capable of being generated in accordance with embodiments;

FIG. 7B is diagram illustrating an exemplary activation circuit using three-phase alternating current (AC) power applied to a motor-power cogeneration unit in accordance with embodiments; and

FIG. 7C is diagram illustrating an exemplary activation circuit with a rectifier for converting alternating current (AC) three-phase power to rectified power for use in activation in accordance with embodiments.

### DETAILED DESCRIPTION

In accordance with various exemplary embodiments discussed and described herein, and by way of brief summary, an exemplary electric motor/power cogeneration unit eliminates or reduces electromagnetic drag and generates electric power from the opposite end of the motor pole irons. Increased load applied to the motor shaft increases the current flow through the motor which, in turn, increases the amount of power generated by the cogeneration coils. The conductors carrying the current load, in connection with various exemplary embodiments, can be wound onto cast iron or laminated steel pole pieces, hereinafter referred to as lateral pole irons, which are then placed in direct proximity to the coil slots of the power cogeneration induction coils which are wound into slots of the laminated steel stator of the generator frame. The cogeneration induction coils can be formed of multiple coils per group with multiple groups being used as needed.

The wound coils on the lateral pole irons form electromagnetic poles wound such that three or more north-pole wound lateral pole irons fire in sequence in a clockwise fashion into each slot of a portion of the power generation induction coils. The conductor associated with the lateral pole iron windings is further wound on the lateral pole irons of a next portion of the power generation induction coils. The coils of the lateral pole irons associated with adjacent portions can be wound in opposite directions to establish alternating magnetic field polarities of the associated poles. The south-pole wound lateral pole irons can also fire in sequence in a clockwise fashion. It should be noted that each of the lateral pole irons can be arranged such that one end portion thereof is seated into a respective one of the slots and the other end portion toward the center of the machine are seated into slots of a non-ferrous ring which can be fixed to the laminated steel generator by a support means. The center oriented ends of the lateral pole irons are flush with the inner surface of the ring.

In another general aspect, the laminated steel generator frame is encased within a circular housing to which end bells containing roller bearings can be attached. The roller bearings can support a mechanism that contains free-wheeling permanent magnet inserts placed into, for example, closed lubricant filled cavities arranged around the outer radius of the mechanism attached to the shaft.

In an exemplary aspect, a first 180° of the free-wheeling permanent magnet insert is constituted of a north pole charged permanent magnet, and the other 180° is constituted of a south pole charged permanent magnet. Cavities, such as lubricant-filled cavities, can contain the free-wheeling permanent magnet inserts, which are held by a containment means and supported by roller bearings. The inserts can further be shielded by a cylinder constituted of a shield having alternating laminations of stainless steel and Mu Metal. The shielded cylinder has a 45° opening to the peripheral surface of the stator by to allow interaction with the opposite magnetic pole of the pole iron. As the stator is electrically activated, such as through passing an excitation current through the windings of the lateral pole irons, the magnetic field generated thereby rotates in a sequential clockwise fashion having an overall field polarity that attracts the opposite poles of the free-wheeling permanent magnet inserts. When the pole portions of the free-wheeling permanent magnet inserts reach dead center alignment with the depthwise axis of the slot and the lateral pole irons, attraction and repulsion of the free-wheeling permanent magnet inserts goes to zero corresponding to minimal electromagnetic drag. The rotating poles of the free-wheeling permanent magnet inserts are spaced such that when a pole of one insert is aligned over, for example, the center of a first north pole wound stator pole in a coil group, a pole of a next insert is dead center over a first south pole wound stator pole of the group. The sequential firing of the north pole—south pole sequence of the stator poles generates power in the power generation induction coils just as a magnetic spinning armature generates power. The sequential firing of the poles also spins the armature thereby generating mechanical power on the motor shaft. As the load on the shaft increases the current flow in the stator coils increases thereby increasing the amount of power generated in the cogeneration coils. The electromagnetic poles of the stator fire in sequence by using the three legs (lines) of a three (3) phase AC power supply. Accordingly, a first electromagnetic pole, such as one of the windings of the lateral pole irons, is energized, then the second is energized. The winding of the third lateral pole iron is energized after the second electromagnetic pole allowing the motor to operate more efficiently since the electromagnetic drag has mostly been eliminated. The cogeneration component takes power off the induction coils and thereby allows less impedance in current flow to neutral and to ground.

The high efficiency electric motor power cogeneration unit provides advantages due to the use of sequential alternating activation and deactivation of magnetic poles associated with attached to the stator through the singular connection of the three phase power supply leads. These magnetic poles interact to sequentially attract free-wheeling permanent magnet inserts. It should be noted that the inserts are primarily capable of attraction and not repulsion since they are free wheeling within their bearing encased support means. The motor operates with minimal electromagnetic drag while power is concurrently generated in the induction coils by the backside of the magnetic poles. As the rotating magnetic field drives the rotor, power generation via the induction coils is increased with increased load on the shaft of the motor. Therefore, the energy gained by the decrease in electromagnetic drag is removed from the system both in the form of electrical and mechanical energy.

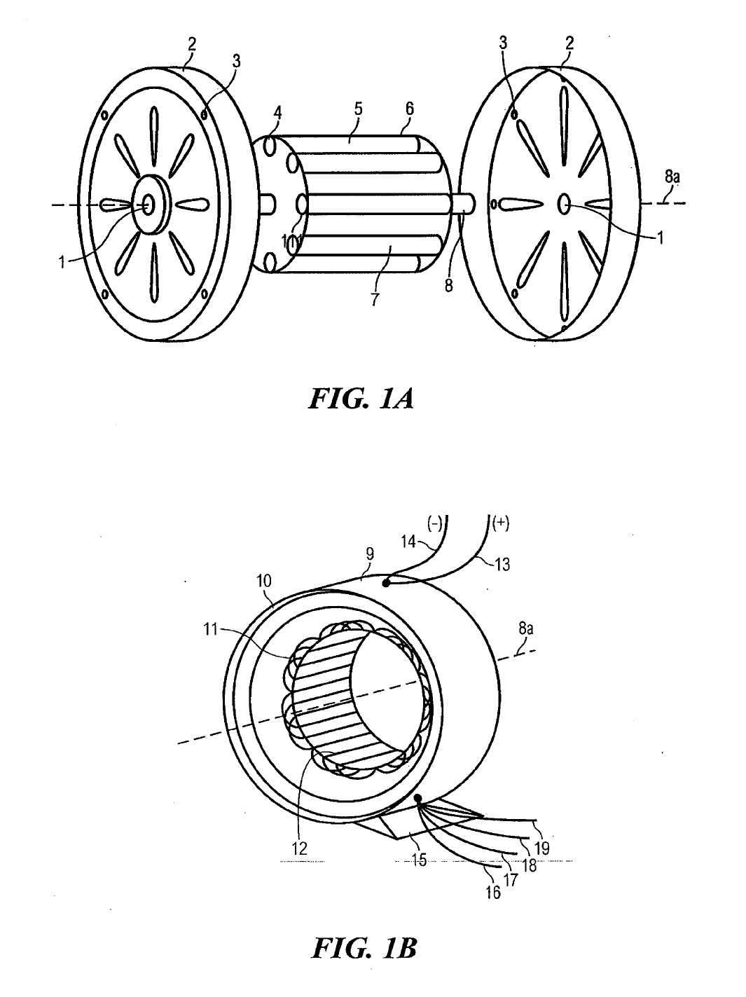

The above overview is exemplary in nature to provide a brief overview of the invention. A better understanding is provided herein below in the description that accompanies the figures. With reference to FIG. 1A thereof, basic components of an exemplary motor/generator are shown. A stator 15 can accommodate a rotor 6 having cavities that hold stator inserts 4 and that have openings 7 that allow flux to escape. The stator inserts 4 accommodate free-wheeling permanent magnet inserts 5. The rotor mechanism can be coupled to a shaft 8, which can be the power drive shaft of an exemplary motor/cogenerator.

Specifically, rotor 6 can be placed inside a stator 15 shown in FIG. 1B. Stator 15 can contain slots, coils, and wound lateral pole irons as will be described in greater detail hereinafter. A shaft 8 can be placed through an opening 1 in end bells 2 that can accommodate, for example, a bearing or similar support mechanism. A common central axis 8a can extend through the shaft 8 and be a common point of reference for the rotor 6, the stator 15, and a support structure for lateral pole irons that will be described in greater detail hereinafter. The unit can be bolted together through holes 3 in each end bell. Input power to the unit can be attached by connecting leads from a power source through corresponding power input leads 16, 17, and 18 and through a neutral (ground) lead 19. The output power leads 13 and 14 from the power generating coils can be attached to appropriate load or distribution circuit.

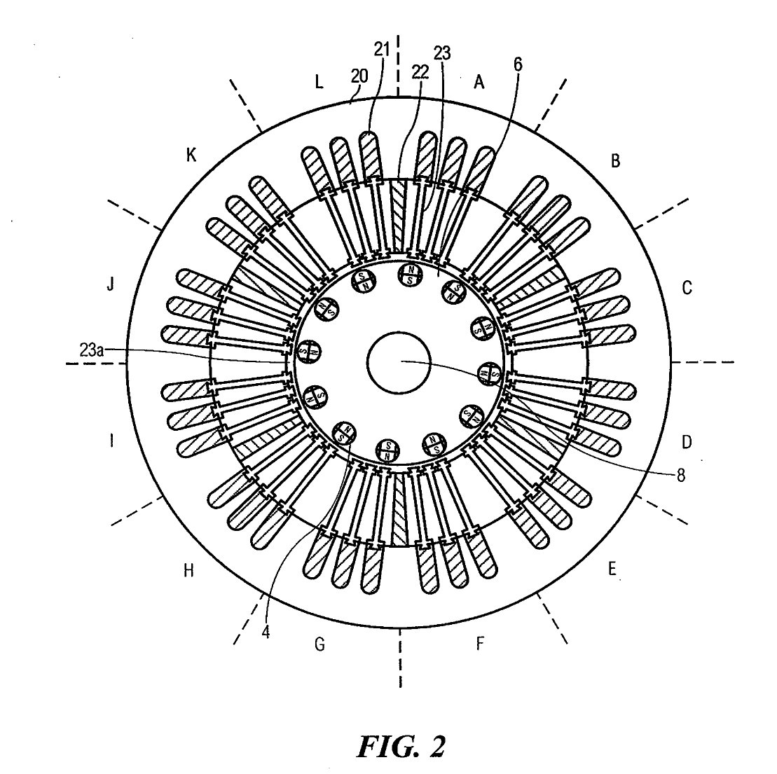

A more detailed understanding of the structure of the stator assembly can be gained with reference to FIG. 2. Therein, in a cross sectional end view laminated stator iron 20, lateral pole irons 23 and rotor 6 are shown. Containment sleeves 4 can accommodate free-wheeling permanent magnet inserts 5 therewithin. Laminated stator iron 20 can contain open wire slots 21 which are insulated and can contain the power induction coils as will be described in greater detail hereinafter. The stator 20 and associated lateral pole iron support structures, for illustration and description purposes, can be divided into sectors such as sectors A-L and allocated with a number of slots 21, which are three in the present example. Each sector can contain a series of slots that are associated with a number of lateral pole irons having lateral pole iron windings wound of a particular magnetic polarity. As the lateral pole irons are fired, through activation of the lateral pole iron windings, a moving magnetic field is developed.

Dividing each set of two sectors, is a support 22 that can be attached to and can support lateral pole iron containment ring 23a, which, in turn, can support the inner ends of the lateral pole irons 23. The outer ends of lateral pole irons 23 are coupled to, contained in, inserted into, adjacent to, magnetically coupled to, or the like, respective ones of the open wire slots 21. While the outer ends of lateral pole irons 23 are illustrated as being inserted into, it will be appreciated that other configurations are possible that position the ends of the lateral pole irons over the slots to allow flux generated within the lateral pole irons to be coupled into the windings. Rotor 6 is positioned on shaft 8 and contains stator inserts 4, which, as noted, are configured to contain free-wheeling permanent magnet inserts 5, within a magnetically shielded containment means that includes a roller bearing support housed in containment sleeve that consists of laminations of mu metal and low or non-ferromagnetic steel such as austenitic stainless steel with an opening on the periphery.

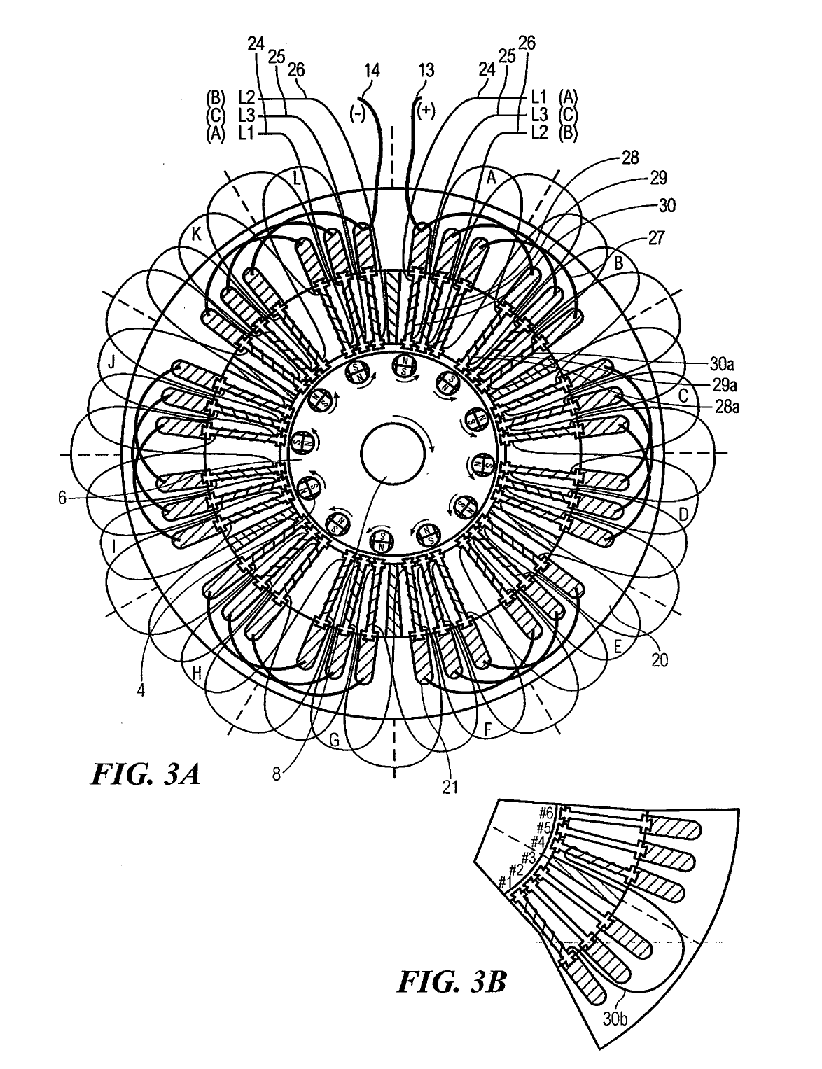

FIG. 3A is a cross sectional end view of an exemplary stator of FIG. 2, revealing further details associated with the lateral pole iron windings and induction coils. The stator laminated iron 20 is equipped with wire slots 21 containing the wound conductors of induction coils 27. Lateral pole irons 23 can be wound, for example, with copper magnet wire of an appropriate size for the current requirements of the application and can be connected to 3-phase leads 24, 25 and 26. The rotor 6 is supported for rotation via the shaft 8 by the bearings in end bells 2, and can turn, for example, in a clockwise direction. The rotor 6 turns when the pole coils are activated in sequence and while the free-wheeling permanent magnet inserts 5 turn, in the present example, in a counter-clockwise direction. During sequential activation of the lateral pole iron windings 28, 29, and 30, and corresponding opposite magnetic polarity lateral pole iron windings 28a, 29a, and 30a, magnetic force from the sequentially activated poles associated with the lateral pole irons interacts with the rotor and the free-wheeling permanent magnet inserts 5 to generate torque on the shaft and thereby create rotation.

The above described arrangement allows more efficient operation than a conventional electric motor by removing much of the electromagnetic drag. In an embodiment, six groups of power generation poles associated, for example, with six sector pairs A-B, C-D, E-F, G-H, I-J, and K-L are each provided with six slots and corresponding six lateral pole irons. In an embodiment, there can be N, sectors, which, in the present example, is twelve. The power generation is accomplished when the lateral pole iron windings fire in sequence. By using the three phases of alternating current (AC) power, that are offset by 120 electrical degrees, a circulating field can be created around the circumference of the stator. In accordance with an embodiment, a first lateral pole iron winding 30 can be wound clockwise and energized by phase (A) of the three-phase power. The resulting field that appears on the end of the lateral pole iron that faces the rotor 6, is a south magnetic pole when phase (A) is positive and north magnetic pole when phase (A) is negative. The second lateral pole iron winding 29 is wound in a counterclockwise fashion and energized by phase (C) such that the resulting field that appears on the end of the lateral pole iron that faces the rotor is a south magnetic pole when phase (C) is negative and a north magnetic pole when phase (C) is positive and will peak 40° after a north pole peak associated with the first lateral pole iron winding 30. The third lateral pole iron winding 28 is wound in a clockwise direction and energized by phase (B) such that the resulting field that appears on the end of the lateral pole iron that faces the rotor is a south magnetic pole in the rotor when phase (B) is positive and north magnetic pole when phase B is negative. Phase B peaks 60° after phase (C). It should be noted that because of the arrangement of the windings and of the application of the three phases, a revolving magnetic field that can generate power and provide a rotational torque is generated.

With regard to the relative phase changes, voltages of phases A, B, and C feed current to the windings in the lateral pole irons in pairs as indicated. A current applied to, for example, the winding of lateral pole iron #1 is fed to the winding of lateral pole iron #4 and so on, from #2 to #5, and #3 to #6 for each of the six groups of two sectors. In each lateral pole iron winding pair, the second pole is wound in the opposite direction from the first pole shown in winding pair 30b in FIG. 3B. By reversing the direction of the winding in every second pole, the poles are energized in sequence to create a rotating field. The rate of rotation of the field depends on the frequency of the alternating current associated with each of the phases. In a typical public power service example, the rate would be 50 or 60 cycles per second. The illustrated connection and winding example along with the hookup and firing sequence continues and generates a revolving magnetic field thereby attracting the free wheeling permanent magnet inserts in stator inserts 4 to rotate to the most advantageous position for attraction by the sequencing electromagnetic poles of the sequentially energized lateral pole irons. Accordingly, repulsive drag and drag by delayed attraction of the poles is reduced or eliminated. The free-wheeling permanent magnet inserts in stator inserts 4 rotate in a counterclockwise direction as rotor 6 rotates in a clockwise direction. The counter rotating motion exerts a torque on shaft 8 and generates a rotational force, for example as a number of horsepower or the like.

In addition to generating rotational torque, the sequential firing or energizing of the windings of the lateral pole irons having first ends that are positioned over induction coils 27 generates power in the induction coils. Experiments reveal that when power is taken from the coils by an electrical load, the impedance in the pole coils decreases thereby increasing generator efficiency.

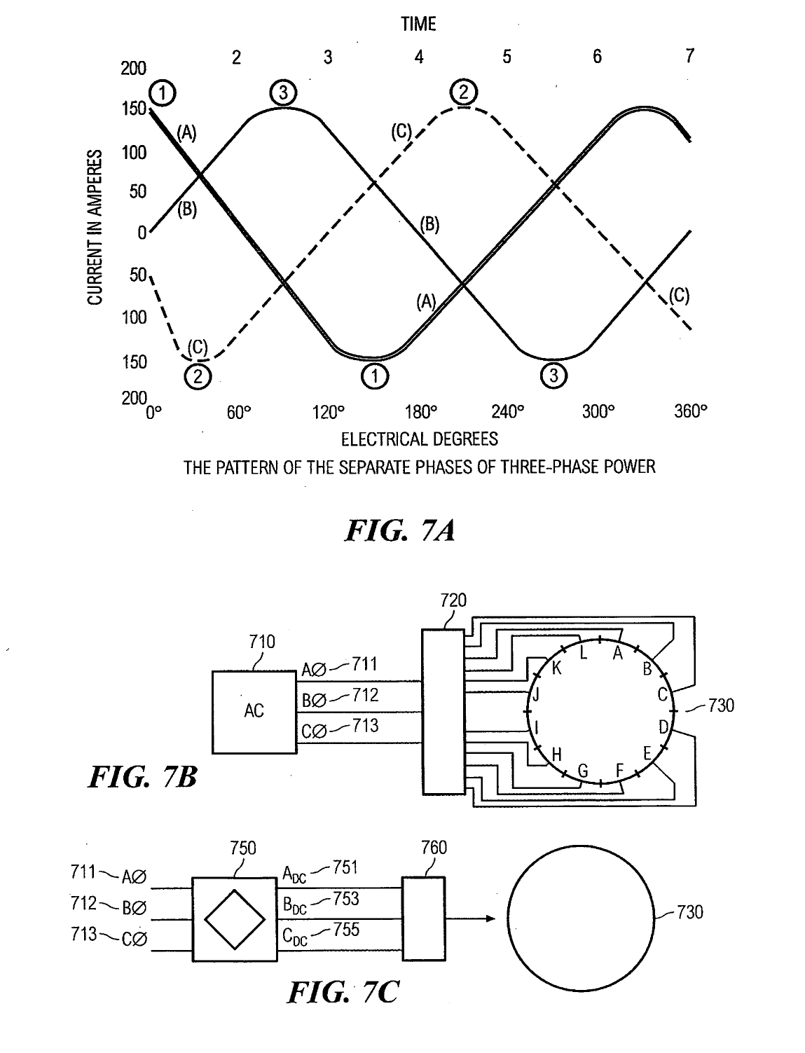

In an alternate embodiment, lateral pole iron windings such as lateral pole iron windings 28, 29 and 30 can be wound such that the first three lateral pole irons, such as #1, #2, and #3 in a group of six are wound in a same counterclockwise fashion and the second three lateral pole irons, such as #4, #5, and #6 are wound in a clockwise fashion. Current from phases A, B and C can be input to a full wave bridge rectifier described herein below in connection with FIG. 7C thereby converting the alternating current (AC) to pulsed DC with each phase spaced 120° from the other phases. For example, in an embodiment, the rectified current from phase A feeds pole 30, phase B feeds pole 29 and phase C feeds pole 28.

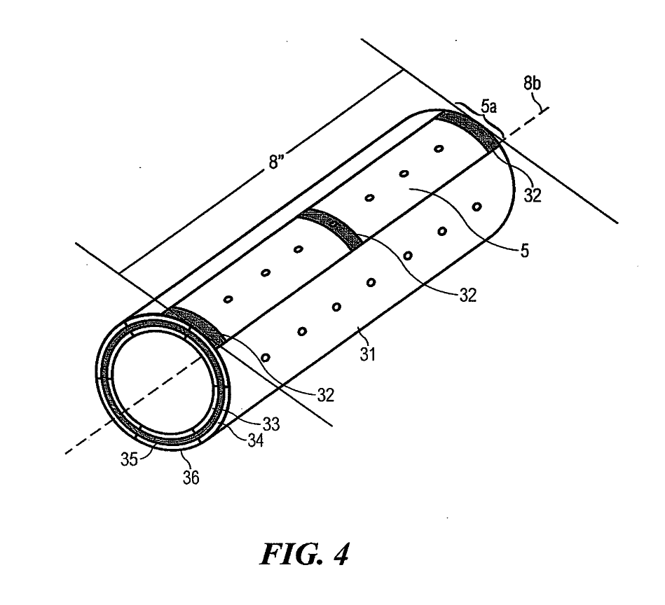

A lateral oblique view of an exemplary containment sleeve associated with a stator insert 4 is shown in FIG. 4. In an embodiment, the length of the sleeve can correspond to the width of an exemplary rotor, such as 8″ in the present example. However the length could be longer or shorter depending on the particular application. The laminations are constituted of non-magnetic materials such as stainless steel or austenitic steel and nickel-iron alloy such as mu metal. While mu-metal provides excellent shielding properties, it is relatively soft compared to stainless steel, which, while providing a degree of shielding is stronger than the mu metal. Therefore the laminations combining stainless steel and mu metal provide excellent strength and magnetic shielding properties. In the event that a magnetic stainless steel is used, the mu metal still provides excellent magnetic shielding properties. The stator insert 4 can be pressed into a cavity machined into the rotor 6. The laminated sleeve 31 can be provided with an opening 5a to allow the magnetic fields associated with the free-wheeling permanent magnet inserts 5 to have unobstructed interaction with an end of a lateral pole iron, such as lateral pole iron 23 shown in FIG. 2. Sequential activation of the lateral pole iron windings 28, 29 and 30, as shown in FIG. 3, results in clockwise or counterclockwise rotation of the rotor 6 depending on the direction of the activation sequence. A bearing support 32 can be provided, and can be formed, for example, as a groove in the sleeve which gives additional structural support and provides a guide for the bearings of the stator insert 4.

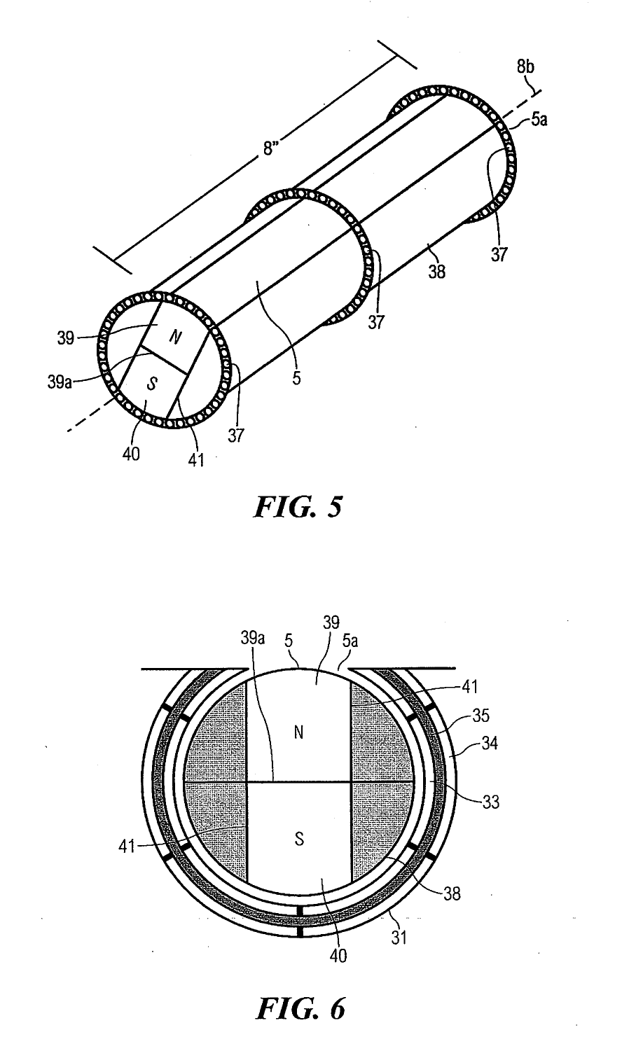

A lateral oblique view of the stator insert 4, which is housed in the above-described laminated stainless steel/mu metal sleeve, is shown in FIG. 5. Each of the sleeves and all of the assemblies pertinent thereto can be arranged along and rotate about a longitudinal axis 8b. The magnet containment means 38 is constructed of non ferro-conductive stainless steel such as austenitic steel or the like. Through open slot or opening 5a, the permanent magnets 39 and 40 can be exposed, for example, the lateral pole iron ends as described above. Permanent magnets 39 and 40 can be constituted of for example, neodymium, samarium-cobalt, or similar quality, high energy product magnetic bodies. Permanent magnet 39 can be bonded to a thin ferro conductive sheet 39a with the north pole facing the outer surface of the containment means. Permanent magnet 40 can be bonded to thin ferro conductive sheet 39a with the south pole facing the outer surface of the containment means. An appropriately sized layer of Mu Metal can be used to form shield 41, which can be bonded to the lateral surface of the permanent magnet 39, sheet 39a and permanent magnet 40. A magnet support 38 can be attached inside above-described laminated sleeve 31, and can provide rotation via ball bearings or roller bearings 37 such that the magnet support means 38 may be turned freely without significant mechanical drag.

FIG. 6 is a representation of an end view of the stator insert 4, including the free-wheeling magnet inserts 5 contained within container means 38, which, in turn, can be contained within the laminated sleeve 31. The stator insert 4 can be contained within cavities that are formed in the periphery of the rotor 6 as described herein above.

As described herein above, FIG. 7A shows the relationship between phases in a three phase power system where phases A, B and C are offset from each other by 120 electrical degrees. As can be seen with reference to FIG. 7B, an alternating current (AC) source 710 can generate three phases Aφ 711, Bφ 712, and Cφ 713 which can be input to sequencer 720, which can be a switching unit or the like as will be appreciated by one of skill in the art. The output of the sequencer can be applied to the various windings of lateral pole irons in motor/co-generator 730 in sectors A-L, as described hereinabove. In connection with various exemplary alternative embodiments, the motor/power cogeneration unit can be driven using rectified AC as shown and described with reference to FIG. 7C. Phases Aφ 711, Bφ 712, and Cφ 713 can be input to a rectifier unit 750, such as a full wave or half wave bridge rectifier, rectifier circuit, or the like. The outputs consisting of phases A_{DC} 751, B_{DC} 752, and C_{DC} 753, can be input to a sequencer 760 to sequentially apply the pulsed-DC output phases A_{DC} 751, B_{DC} 752, and C_{DC} 753 to corresponding windings of lateral pole irons in motor/co-generator 730 as described above.

White embodiments have been described and illustrated, it will be understood by those skilled in the technology concerned that many variations or modifications in details of design or construction may be made without departing from the present invention. For example, while the permanent magnets are described herein as being made from neodymium, samarium-cobalt magnets could also be used particularly where high temperature applications are needed. Further, while motor windings are described herein as being arranged in coil groups of three per sector, other arrangements are possible and winding can be accomplished in a variety of ways such as wound copper conductors, insulated winding bars and the like, without departure from the inventive gist.

1. A method for reducing drag in an electric motor-power co-generator comprising:
forming a series of wound lateral pole irons around the inner periphery of a stator, the stator having slots disposed around the inner periphery, the slots containing induction windings, first ends of the lateral pole irons extending into the slots, the lateral pole irons supported by a lateral pole iron support structure forming a circular opening concentric with the inner periphery of the stator, second ends of the lateral pole irons extending towards the circular opening;
distributing stator inserts containing free-wheeling permanent magnet inserts along an outer periphery of a rotor inserted into the circular opening of the lateral pole iron support structure, the free-wheeling permanent magnet inserts inserted into cavities along the outer periphery of the rotor, the permanent magnet inserts each having a pair of pole sections with a first magnetic polarity and a second magnetic polarity; and
sequentially energizing the windings of the lateral pole irons so as to provide a moving field to generate a torque applied to rotate the rotor, and pole sections of the free-wheeling permanent magnet inserts being free to rotate into alignment with ones of the second ends of the lateral pole irons to increase a flux density in the lateral pole irons, the first ends of the lateral pole irons inducing a current flow into the induction windings.

2. The method of claim 1, further comprising:
dividing the stator, the support structure, and the rotor into N equally spaced sectors by radii emanating from a common center point on a common central longitudinal axis and inserting the free-wheeling permanent magnet inserts into positions along the outer periphery of the rotor;
forming N/2 groups of two of the N equally spaced sectors; and
winding first ones of the lateral pole iron windings in first ones of the sectors in the N/2 groups such that the first lateral pole irons have a first magnetic polarity and winding second ones of the lateral pole iron windings in second ones of the sectors in the N/2 groups such that the second lateral pole irons have a second magnetic polarity.

3. The method of claim 1, wherein the slots, the lateral pole irons and the free-wheeling permanent magnet inserts are axially aligned along a respective lengthwise axis thereof such that a lengthwise axis of the free-wheeling permanent magnet inserts is in normal alignment with a depthwise axis of the slots and lateral pole irons.

4. The method of claim 1, further comprising magnetically shielding the free-wheeling permanent magnet inserts within the rotor such that flux generated thereby is coupled directly into the second ends of the lateral pole irons so as to minimize flux leakage and magnetic drag.

5. The method of claim 1, wherein the distributing the free-wheeling permanent magnet inserts further includes inserting the free-wheeling permanent magnet inserts into respective openings provided in the rotor, the respective openings arranged in lengthwise alignment with the slots and the lateral pole irons, the openings corresponding to a longitudinal opening of the slots, to provide magnetic communication with the corresponding second ends of the lateral pole irons.

6. The method of claim 1, wherein the sequentially energizing the windings of the lateral pole irons so as to provide a moving field includes bringing first ones of the free-wheeling permanent magnet inserts into alignment with first ones of the second ends of the lateral pole irons such that, as the torque is provided to rotate the rotor, the first ones of the free-wheeling permanent magnet inserts maintain the alignment with the first ones of the second ends of the lateral pole irons such that, as the rotor rotates past the second ends of the lateral pole irons, a maximum flux density associated with the moving field is maintained so as to induce a maximum current flow in the induction windings and reduce a magnetic drag associated with the rotation.

7. The method of claim 1, wherein N is equal to 12.

8. The method of claim 1, further comprising forming the pole sections from neodymium.

9. The method of claim 1, further comprising forming the pole sections from samarium-cobalt.

10. An electromagnetic assembly for an electric motor and power co-generation comprising:
a stator having a plurality of slots arranged on a stator periphery of an inner stator opening thereof;
a plurality of lateral pole irons coupled to the stator such that first ends of each of the plurality of lateral pole irons are coupled to respective ones of the plurality of slots, the slots and the lateral pole irons aligned along a lengthwise and depthwise axis, the plurality of lateral pole irons supported by a support structure that is positioned within the inner stator opening on a common central axis, the support structure having a support structure opening in the center thereof, the lateral pole irons having windings and second ends directed toward the support structure opening; and
a rotor positioned within the support structure opening, the rotor having a plurality of cavities on a rotor outer periphery, the rotor coupled to a central shaft; and
a plurality of free-wheeling permanent magnet inserts inserted into the cavities, each of the plurality of free-wheeling permanent magnet inserts has a pair of magnetic pole sections having a first magnetic polarity and a second magnetic polarity, each of the free-wheeling permanent magnet inserts being capable of rotating about a longitudinal axis,
wherein the windings of the plurality of lateral pole irons are sequentially energized to create a moving field and a torque on the rotor causing a rotation of the shaft, the free-wheeling permanent magnet inserts rotating into alignment with the second ends of energized ones of the lateral pole irons and free-wheeling to maintain alignment as the rotor and the field rotates so as to provide maximum flux density in the lateral pole iron and the induction windings in a corresponding one of the plurality of slots to induce a current flow therein.

11. The electromagnetic assembly of claim 10, wherein the stator, the support structure and the rotor are divided into N equally spaced sectors by radii emanating from a common center point on a common central longitudinal axis.

12. The electromagnetic assembly of claim 10, further comprising an activation circuit coupled to the windings of the lateral pole irons, activation circuit applying three phases of alternating current power to sequentially energize ones of the windings of the lateral pole irons.

13. The electromagnetic assembly of claim 10, further comprising an activation circuit coupled to the windings of the lateral pole irons, activation circuit including a rectifier circuit for applying rectified versions of three phases of alternating current power to sequentially energize ones of the windings of the lateral pole irons.

14. The electromagnetic assembly of claim 10, wherein each of the plurality of the lateral pole irons are disposed respectively above each of the plurality of the slots such that the induction coil windings disposed in the plurality of slots are exposed to a concentrated amount of magnetic flux generated when the windings of the lateral pole irons are energized and a magnetic circuit is completed by the free-wheeling permanent magnet inserts.

15. The electromagnetic assembly of claim 10, wherein the plurality of free-wheeling permanent magnet inserts are further capable of rotating in synchronized relation with the magnetic field such that when the windings of the lateral pole irons are sequentially energized, the free-wheeling permanent magnet inserts are rotated into alignment with the second ends of the lateral pole irons so as to provide maximum flux density in the induction windings to induce a current flow therein and to reduced magnetic drag on the rotor.

16. The electromagnetic assembly of claim 10, wherein each of the cavities has an opening capable of being positioned adjacent to the second ends of the lateral pole irons.

17. The electromagnetic assembly of claim 10, wherein each of the plurality of free-wheeling permanent magnet inserts is contained within a containment sleeve that shields the rotor from magnetic fields produced by each of the free-wheeling permanent magnet inserts.

18. The electromagnetic assembly of claims 17, wherein the containment sleeve is made from alternating layers of mu metal and austenitic steel.

19. The electromagnetic assembly of any of the preceding claims, wherein each of the stator and the support structure has a substantially circular shape.

20. The electromagnetic assembly of claim 10, wherein each of the plurality of free-wheeling permanent magnet inserts is contained within a containment sleeve having one or more bearings to support rotation of the containment sleeve and the contained free-wheeling permanent magnet insert member.

21. The electromagnetic assembly of any of the preceding claims, wherein the pole sections are formed from neodymium.

22. The electromagnetic assembly of any of the preceding claims, wherein the pole sections are formed from samarium-cobalt.

23. The electromagnetic assembly of claim 10, further comprising a rectifier circuit.
